(19) United States
(12) Patent Application Publication
(10) Pub. No.: US 2017/0225507 A1
(43) Pub. Date: Aug. 10, 2017

(54) Illuminable Writing Implement

(71) Applicant: SLIS Inc. (Really Useful Products, Inc.), Darien, IL (US)

(72) Inventor: Jiadong Ma, Darien, IL (US)

(21) Appl. No.: 15/018,760

(22) Filed: Feb. 8, 2016

(51) Int. Cl. B43K 29/10; F21L 4/00; F21V 23/04; B43K 24/12; B43K 7/00

(52) U.S. Cl. CPC B43K 29/10; B43K 24/12; B43K 7/005; F21V 23/0414; F21L 4/00; F21Y 2115/10

(57) ABSTRACT

An illuminable writing implement includes a housing having a transparent or translucent wall, an insert member disposed within the housing and visible through the housing wall, a writing tip supported by the housing, and a light source disposed in the housing and configured to illuminate the insert member when the light source is supplied with power.

### FIELD OF THE DISCLOSURE

The present description relates generally to writing implements, including pens, pencils, markers, and the like.

### BACKGROUND OF RELATED ART

Writing implements, such as pens, pencils, and markers, are generally known. Such writing implements may be generally customized for novelty, promotional, or other purposes by printing a name, logo, slogan, etc. on an exterior surface of the writing implement.

### BRIEF DESCRIPTION OF THE DRAWINGS

FIG. 1 is an isometric view of an exemplary illuminable pen.

FIG. 2 is a front view of the exemplary illuminable pen of FIG. 1.

FIG. 3 is rear view of the exemplary illuminable pen of FIG. 1.

FIG. 4 is a right-side view of the exemplary illuminable pen of FIG. 1.

FIG. 5 is a left-side view of the exemplary illuminable pen of FIG. 1.

FIG. 6 is an end view of the exemplary illuminable pen of FIG. 1.

FIG. 7 is an end view of the exemplary illuminable pen of FIG. 1.

FIG. 8 is an exploded view of the exemplary illuminable pen of FIG. 1.

### DETAILED DESCRIPTION

Known novelty and promotional writing implements can be improved upon by providing illumination to the novelty or promotional aspect of the implement. Additionally or alternatively, known novelty and promotional writing implements can be improved upon by providing one or more eye-catching symbols (e.g., logos or designs) or words (e.g., names or slogans) on an interior aspect of the writing implement, along with an external feature through which the symbol or words can be seen. For example, a housing of the writing implement may have a transparent or translucent wall through which the symbol or words are visible.

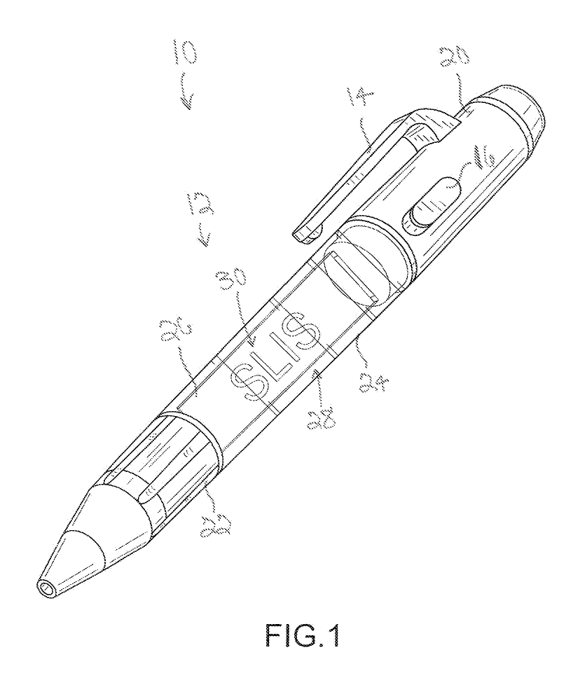

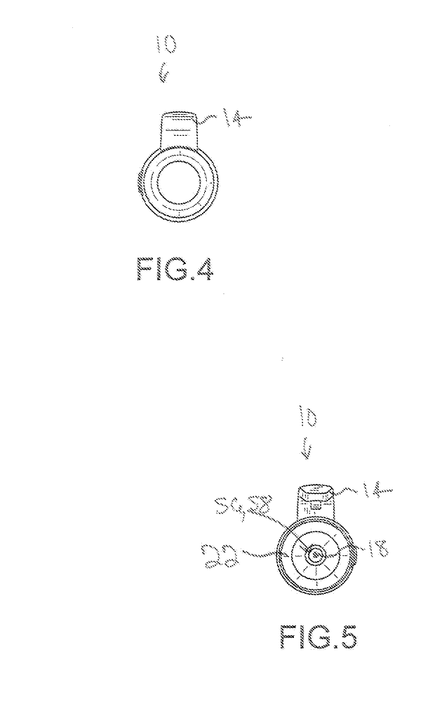

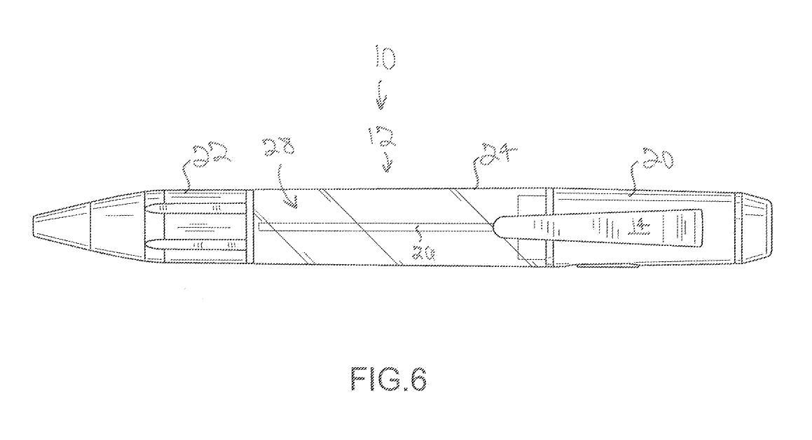

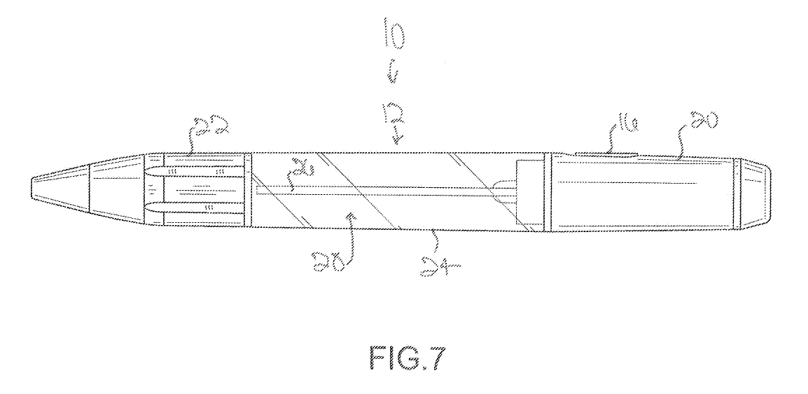

Referring to the figures, wherein like reference numerals refer to the same or similar features in the various views, FIGS. 1-7 illustrate some features of an exemplary illuminable pen 10 (which may be referred to in this disclosure simply as “the pen 10” for ease of discussion). The exemplary pen 10 includes a housing 12, a clip 14, a switch 16, and a writing tip 18.

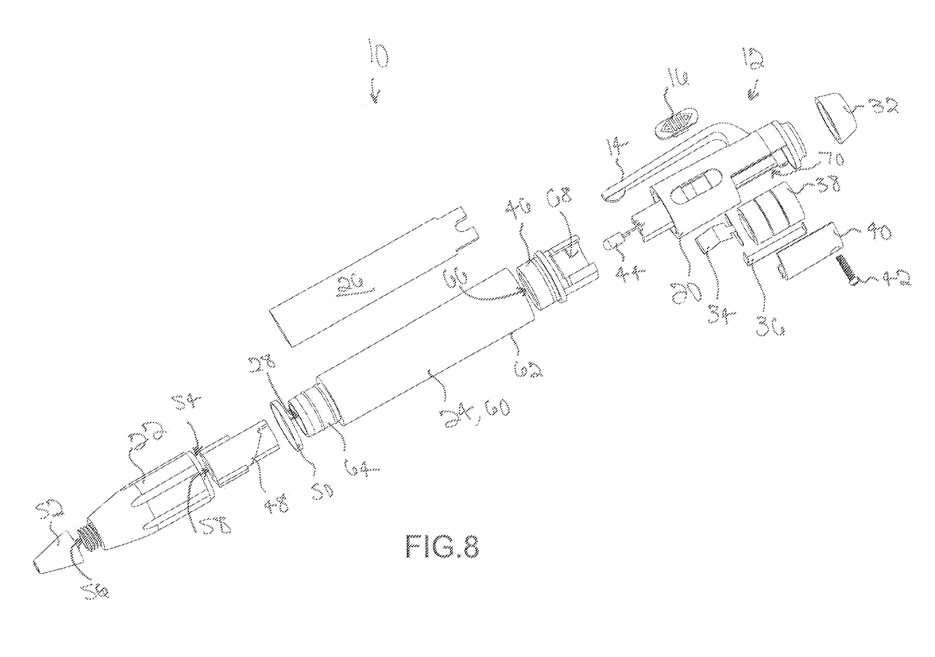

The housing 12 of the example pen 10 includes three portions: a first end portion 20, a second end portion 22, and an intermediate portion 24. Referring to FIG. 8, the first end portion 20 of the exemplary housing 12 supports or contains a light source 44 and an associated battery pack 38 and electrical connectors 34, 36. The intermediate portion 24 provides a visibility path to an insert member 26 that can be disposed within the housing 12 and illuminated by the light source 44, and the second end portion 22 contains or supports the writing tip 18 (see FIG. 5). The switch 16 of the exemplary pen 10 is disposed on the housing 12 (e.g., on the first end portion 20 of the housing 12) and is configured to activate and deactivate the light source 44 by selectively electrically coupling the light source 44 with the battery pack 38, we will be described in detail later in this disclosure.

Referring again to FIGS. 1-7, as in known writing implements, the clip 14 is provided to enable a user to clip the pen 10 to a shirt, pocket, folder, etc.

The writing tip 18 is provided in and supported by the second end portion 22 of the housing 12 of the exemplary pen 10. The writing tip 18 may be a ballpoint pen mechanism, fountain pen mechanism, felt-tip pen mechanism, rollerball pen mechanism, other pen mechanism, or other writing implement mechanism. Accordingly, although this disclosure will make reference to a “pen,” it should be understood that the teachings of this disclosure may find use with other writing implements, as well, including but not limited to pencils (e.g., mechanical pencils), markers, and the like.

The writing tip 18 may be selectively retractable. For example, in the illustrated exemplary pen 10, the writing tip may be retracted and exposed by twisting the second end portion 22 of the housing 12 relative to the rest of the housing 12.

An exemplary insert member 26 is disposed within the housing 12 and is visible through the intermediate portion 24 of the housing 12, in the exemplary pen 10. The exemplary insert member 26 is a band or ribbon that may be disposed in a cavity 28 of the intermediate housing portion 24. In the illustrated example, the insert member 26 is straight, that is, not looped or twisted. In other examples, the insert member 26 may be twisted or looped. The insert member 26 may be either rigid or flexible. The insert member 26 may be made from a transparent or translucent material, and the material of the insert member 26 may conduct light. For example, the insert member 26 may be made from a polymer, such as thermoplastic polyurethane (TPU). The insert member 26 may be colored or colorless. The insert member 26 may include one or symbols or words 30, that are etched, engraved, incised, or otherwise impressed on or in the insert member 26. For example, one or more symbols or words 30 may be impressed on a first surface of the band of the insert member 26. The symbols or words 30 may be, for example only, logos, designs, names, slogans, and the like. In the illustrated exemplary pen, the symbols or words 30 are “SLIS.” Of course, this is exemplary in nature only.

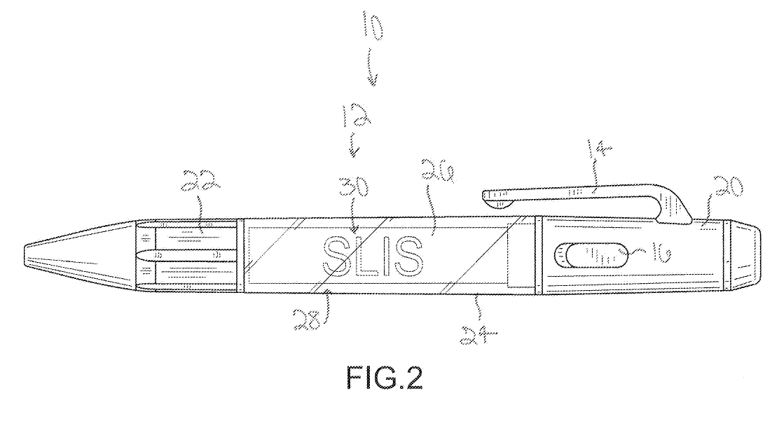

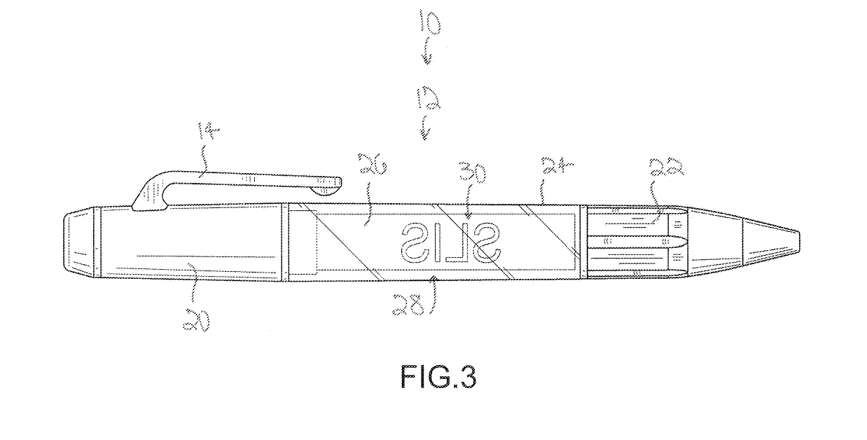

As can be seen by comparing FIG. 2, which illustrates the side of the insert member 26 on which the symbols or words 30 are impressed, with FIG. 3 which illustrates the side of the insert member 26 on which the symbols or words 30 are not impressed, the insert member 26 may be transparent or translucent such that the symbols or words 30 are visible through the insert member 26. Accordingly, the symbols or words 30 may be visible even from a side of the insert member 26 on which the symbols or words 30 are not impressed, as illustrated in FIG. 3.

Referring to FIG. 8, the interior features and functionality of the exemplary pen 10 will be described, and the exterior features will be described in greater detail. As shown in FIG. 8, the exemplary pen 10 includes a first end cap 32, the first end portion 20 of the housing 12, the switch 16, first and second electrical contact members 34, 36, a battery pack 38, a housing plate 40, a housing plate screw 42, a light source 44, an insert member support 46, the intermediate portion 24 of the housing 12, the insert member 26, a twist mechanism 48, an annular band 50, the housing second end portion 22, and a second end cap 52.

The second end cap 52 is coupled to the second end portion 22 of the housing 12, in the exemplary pen 10. The interior of the exemplary second end cap and the exterior of the exemplary second end portion 22 of the housing 12 have complementary threads so that the first end cap can be screwed onto the second end portion 22 of the housing 12. In another example, the first end cap may be coupled with the second end portion 22 of the housing 12 with some other attachment mechanism, such as friction-fit, adhesive, etc. In yet another example, the first end cap may be unitary with (i.e., made from the same piece of material as) the second end portion 22 of the housing 12.

The second end portion 22 of the housing 12 includes a cavity 54 in which the twist mechanism 48 may be disposed in the assembled pen 10. The second end portion 22 of the housing 12 also has a through-bore 56 that is contiguous with the cavity 54. The writing tip 18 (see FIG. 5) may be disposed within and/or extend through the through-bore 56.

Referring again to FIGS. 5 and 8, the twist mechanism 48 has a bore 58 configured to receive the writing tip 18. The twist mechanism 48 may be coupled within the second end portion 22 of the housing 12 so that, responsive to a twisting motion, the writing tip 18 extends out of or retracts into the twist mechanism 48. Accordingly, the writing tip 18 of the exemplary pen 10 extends out of or retracts into the housing 12 responsive to a user twist on the second end portion 22. In other examples, the pen 10 may be equipped with other mechanisms for user access to the writing tip 18, such as a click mechanism or another type of twist mechanism, or a permanently exposed writing tip.

The intermediate portion 24 of the housing 12 includes a hollow cylindrical portion 60 having a wall 62 and a central cavity 28, in the illustrated example. The wall 62 of the hollow cylindrical portion 60 may be transparent or translucent. The exemplary intermediate housing portion 24 further includes an extension portion 64 that couples with the second end portion 22 of the housing 12, in the example pen 10. The central cavity 28 may extend into and through the extension portion, as illustrated in FIG. 8. The intermediate portion 24 of the housing 12 is coupled with the second end portion 22 of the housing 12 so that the second end portion 22 of the housing 12 may twist relative to the intermediate portion 24, in the exemplary pen 10.

The exemplary insert member support 46 includes a receiving formation 66 in which an end of the insert member 26 may be received and secured. For example, the receiving formation 66 may be a slot, aperture, or other appropriate formation. For the remainder of this disclosure, the receiving formation 66 will be referred to as a slot 66, but it should be understood that the receiving formation 66 is not necessarily limited to a slot except as expressly set forth in the claims.

The exemplary insert member support 46 may be removably coupled with the intermediate housing portion 24 and/or with the first end portion 20 of the housing 12 through friction-fit or some other mechanical coupling. When the exemplary pen 10 is assembled, the insert member support 46 may be wholly or partially disposed within the intermediate portion 24 of the housing 12 and/or the first end portion 20 of the housing 12. Accordingly, in the illustrated example, the exemplary insert member support 46 secures and disposes the insert member 26 within the intermediate housing portion 24 when the exemplary pen 10 is assembled with the insert member 26 therein.

The exemplary insert member support 46 further includes a cavity 68 configured to receive the light source 44 and to position the light source 44 so that, when provided with power, the light source 44 projects light on to the insert member 26 and/or in to the intermediate housing portion 24. In the exemplary insert member support 46, the slot 66 is contiguous with the cavity 68, so that the light source 44 may be arranged within the cavity 68 so as to project light into the slot 66 and therefore onto the insert member 26 when secured within the slot 66. In addition, in the exemplary pen 10, the cavity 68 of the insert member support 46 may be disposed within the first end portion 20 of the housing 12, with the slot 66 positioned so that the light source 44 projects light in the direction of the second end portion 22 of the housing 12.

Although shown as separate elements in the illustrated exemplary pen 10, the insert member support 46 and the first end portion 20 of the housing 12 may be a single element, in another example. In yet another example, the insert member support 46 and the intermediate portion 24 of the housing 12 may be a single element. In still another example, the slot 66 of the insert member support 46 may be provided on the intermediate portion 24 of the housing 12, and the cavity 68 of the insert member support 46 may be provided on the first end portion 20 of the housing 12. Of course, still other modifications to the exact structure of the pen may also be possible and are contemplated.

The light source 44 is configured in size and shape to be received and secured within the insert member support 68 and to project light when supplied with power. The light source 44 may include one or more light-emitting diodes (LEDs), in one example. Additionally or alternatively, the light source 44 may include a laser, incandescent bulb, fluorescent bulb, high-intensity discharge bulb, or other appropriate source of light. The light source 44 may provide light at any appropriate frequency and brightness. In addition, the frequency and brightness of the light source 44 may be static, or may be adjustable. For example, the pen 10 may be provided with electronics to modulate the frequency of the light source 44 responsive to actuation of the switch 16.

The battery pack 38, electrical contacts 34, 36, and switch 16 collectively enable power to be supplied to the light source 44. In the illustrated example, the battery pack 38 includes three battery cells, electrically connected to each other in series. In other examples, the battery pack 38 may include another number or arrangement of battery cells. That is, the battery pack 38 may include one or more battery cells, and those cells may be electrically coupled with each other in parallel or in series, in various examples.

In the exemplary pen 10, the electrical contacts selectively electrically couple the light source 44 to the battery back 38 responsive to actuation of the switch 16, as known in the art. That is, a first position of the switch 16 results in an OFF state of the light source, and a second position of the switch 16 results in an ON state of the light source. Accordingly, the light source may be selectively turned ON or OFF by a user through the switch 16.

In other examples of the pen 10, the light source may be controllable with a dimmer mechanism, a programmed circuit, a type of switch 16 different from the exemplary switch 16 illustrated in the figures, or with some other control mechanism.

The first end portion 20 of the housing 12 includes a cavity 70 in which the battery pack 38 and electrical contacts 34, 36 are disposed, in the exemplary pen 10. In the exemplary pen 10, the cavity 70 is covered and/or sealed by the housing plate 40, which is coupled to the first end portion 20 of the housing 12 by the housing plate screw 42. The second end cap 32 may be coupled with the end of the first end portion 20 of the housing 12 via friction-fit, complementary threads, or some other mechanical coupling mechanism.

The housing portions 20, 22, 24 and insert member 26 may be made from plastic, in an example, using one or more of the following example techniques: injection molding, extrusion molding, vacuum forming, and/or compression molding. The housing portions 20, 22, 24 and insert member 26 may be formed from the same material through the same technique, or may be formed from different materials through different techniques.

One or more of the housing portions 20, 22, 24 and the insert member 26 may be transparent or translucent, in an example. For example, in one example, the second end portion 22 of the housing 12, the intermediate portion 24 of the housing 12, and the insert member 26 may be made from transparent or translucent plastic, and the first end portion 20 of the housing 12 may be made from opaque plastic.

In operation, the light source 44 may be selectively activated and deactivated by a user through use of the switch 16. When activated, the light source may project light into the slot 66 and into/onto the insert member 26. The insert member 26 may conduct the light so as to illuminate itself and to illuminate/highlight any symbols and/or words 30 (not shown in FIG. 8 for clarity of illustration) impressed on the insert member 26. As a result, the symbols or words 30 may be lit from within the insert member 26. Additionally or alternatively, the symbols or words 30 may be lit from the exterior of the insert member 26. For example, the light source 44 may be positioned to project light through a slot, aperture, etc. in the insert member support 46 that is offset from the insert member 26, or to otherwise project light directly onto the surface of the insert member 26 on which the symbols or words 30 are impressed.

Although certain embodiments of the present invention have been described herein, it is not intended that the disclosure be limited merely to those embodiments. The foregoing description and drawings are merely to explain and illustrate the invention and the invention is not limited thereto except insofar as the appended claims are so limited, as those skilled in the art who have the disclosure before them will be able to make modifications and variations therein without departing from the scope of the invention.

What is claimed is:

1. An illuminable writing implement, comprising:
a housing having a transparent or translucent wall;
an insert member, disposed within the housing and visible through the housing wall;
a writing tip supported by the housing; and
a light source disposed in the housing and configured to illuminate the insert member when the light source is supplied with power.

2. The illuminable writing implement of claim 1, further comprising one or more symbols or words engraved, etched, or incised on a surface of the insert member.

3. The illuminable writing implement of claim 2, wherein the insert member comprises a band, the one or more symbols being engraved, etched, or incised on a surface of the band.

4. The illuminable writing implement of claim 3, wherein the band is transparent or translucent.

5. The illuminable writing implement of claim 2, wherein the insert member comprises thermoplastic polyurethane.

6. The illuminable writing implement of claim 1, wherein:
the housing comprises first and second portions;
the light source is disposed in the first portion of the housing; and
the second portion of the housing comprises the transparent or translucent wall.

7. The illuminable writing implement of claim 6, further comprising a battery disposed in the first portion of the housing.

8. The illuminable writing implement of claim 7, further comprising a switch disposed on the housing and configured to selectively electrically couple the light source with the battery.

9. The illuminable writing implement of claim 2, further comprising a insert member support disposed in the housing, configured to support the light source, and having a receiving formation for receiving the insert member and securing the insert member relative to the light source.

10. The illuminable writing implement of claim 9, wherein the insert member support is removably coupled with the second portion of the housing.

11. An illuminable writing implement, comprising:
a housing;
a support disposed within the housing, the support comprising a slot for receiving an insert member and securing the insert member within the housing, the insert member visible through the housing when secured within the slot;
a writing tip supported by the housing; and
a light source disposed in the housing and configured to illuminate the insert member when the light source is supplied with power.

12. The illuminable writing implement of claim 11, further comprising an insert member disposed in the slot.

13. The illuminable writing implement of claim 12, wherein the insert member comprises a transparent or translucent band.

14. The illuminable writing implement of claim 11, wherein the light source is supported by the support and arranged so as to project light through the slot onto the insert member.

15. The illuminable writing implement of claim 11, wherein the light source is disposed at a first end portion of the housing, the writing tip is supported by a second end portion of the housing, and the light source is arranged so as to project light towards the second end portion.

16. The illuminable writing implement of claim 15, the housing comprising a cavity in the first end portion of the housing for receiving a battery.

17. The illuminable writing implement of claim 16, further comprising a switch provided at the first end portion of the housing, the switch configured to selectively electrically couple the light source with a battery disposed in the cavity.

18. The illuminable writing implement of claim 16, further comprising a battery disposed in the cavity.

19. The illuminable writing implement of claim 15, wherein the housing comprises an intermediate portion between the first end portion and the second end portion, the intermediate portion comprising a transparent or translucent wall through which the insert member is visible when secured in the slot.

20. The illuminable writing implement of claim 19, wherein the intermediate portion of the housing comprises a plastic cylinder.
